(19) United States
(12) Patent Application Publication
(10) Pub. No.: US 2006/0228506 A1
(43) Pub. Date: Oct. 12, 2006

(54) Abrasion resistant composite material structure

(76) Inventor: A. P. Lin, Chang Hwa City (TW)

Correspondence Address: CHARLES E. BAXLEY, ESQ., 90 JOHN STREET, THIRD FLOOR, NEW YORK, NY, 10038, US

(21) Appl. No.: 11/103,073

(22) Filed: Apr. 11, 2005

(51) Int. Cl. B32B 5/16; B32B 27/30; B32B 9/00

(52) U.S. Cl. 428/36.91; 428/698; 428/522; 428/323

(57) ABSTRACT

The present invention relates to an abrasion resistant composite material structure whose surface is laminated with an abrasion resistant layer, so that the composite material structure can be kept from abrasion.

### BACKGROUND OF THE INVENTION

1. Field of the Invention

The present invention relates to a composite material product, and more particularly to an abrasion resistant composite material structure.

2. Description of the Prior Arts

Since composite material has the advantages of high strength, high toughness, lightweight and corrosion resistance, products made of composite material have found a wide application in different fields, such as aviation industry, marine transport, land transport facilities, sports and leisure equipments. However, the composite material products still have the following defects:

As far as a bicycle seat post made of composite material is concerned, as shown in FIG. 1, in which, the seat post 11 is made of composite material (such as carbon fiber) and is lightweight, however, the shortcoming of the composite material is less wearable, so that the seat post 11 may be scratched and worn off after being assembled with the seat tube 12. Furthermore, the seat post 11 must have a force-bearing portion 111 that is to be assembled with the seat tube 12, therefore, the force-bearing portion 111 of the seat post may be scratched when it is assembled to the seat tube 12.

The present invention has arisen to mitigate and/or obviate the afore-described disadvantages.

### SUMMARY OF THE INVENTION

The primary objective of the present invention is to provide an abrasion resistant composite material structure whose surface is laminated with an abrasion resistant layer, so that the composite material structure can be kept from abrasion.

To achieve this goal, an abrasion resistant composite material structure in accordance with the present invention is provided and comprises a abrasion resistant layer formed on a composite material product, and the abrasion resistant layer serves as an abutment portion of the composite material product to other components.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a seat post made of composite material in accordance with the present invention;

FIG. 2 is a perspective view of a composite material tube in accordance with a first embodiment of the present invention;

FIG. 3 is a cross sectional view of a composite material tube in accordance with the first embodiment of the present invention;

FIG. 4 is an operational view of showing a composite material seat post in accordance with the first embodiment of the present invention being assembled with the seat tube;

FIG. 5 is an operational view of showing a composite material seat post in accordance with the first embodiment of the present invention being assembled with the bicycle seat;

FIG. 6 is an operational view of showing a composite material handlebar in accordance with the first embodiment of the present invention being assembled with the handle stem;

FIG. 7 is an operational view of showing a composite material bicycle handle stem in accordance with the first embodiment of the present invention being assembled with the front fork of a bicycle;

FIG. 8 is an operational view of showing a composite material bicycle frame in accordance with a second embodiment of the present invention being assembled with the rear wheel.

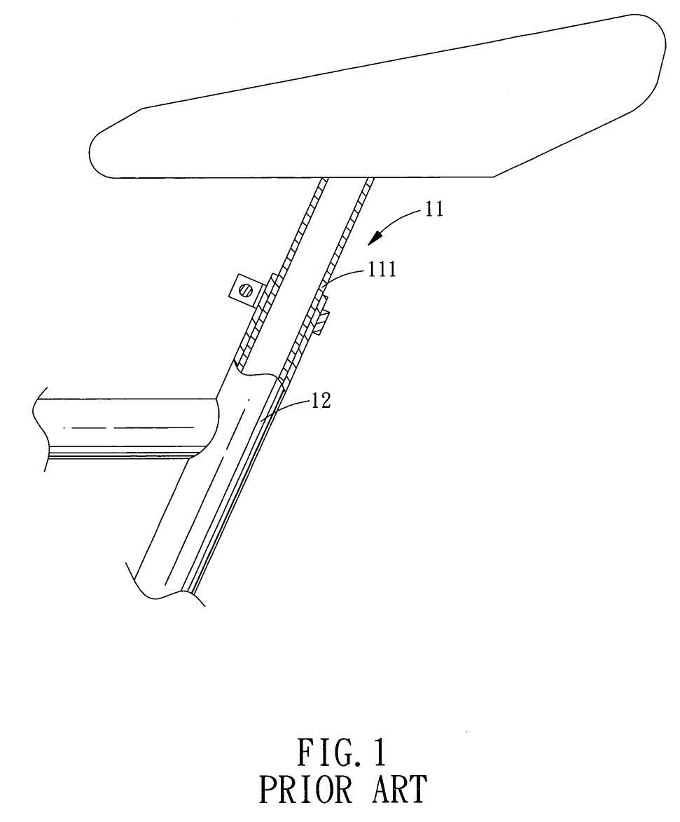

### DETAILED DESCRIPTION OF THE PREFERRED EMBODIMENTS

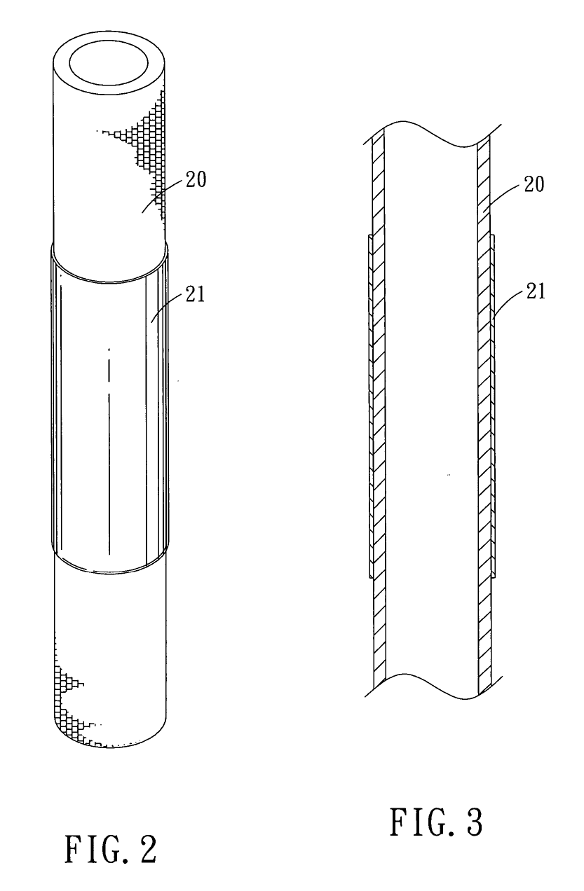

Referring to FIGS. 2 and 3, an abrasion resistant composite material structure in accordance with a first preferred embodiment of the present invention comprises an abrasion resistant layer 21 that is formed on the outer surface of a composite material tube 20 by means of paint spraying or any other processes. The abrasion resistant layer 21 is made of Molybdenum Disulfide, Acrylics, nano-composite coating material, polyester coating material, or any other abrasion resistant materials and serves as an abutment that is to be assembled with other components. By such arrangements, the abrasion resistant layer 21 can prevent the surface of the composite material tube 20 from being scratched, so that the composite material tube 20 not only possesses the inherent characteristics of composite material, but also has high resistance to abrasion.

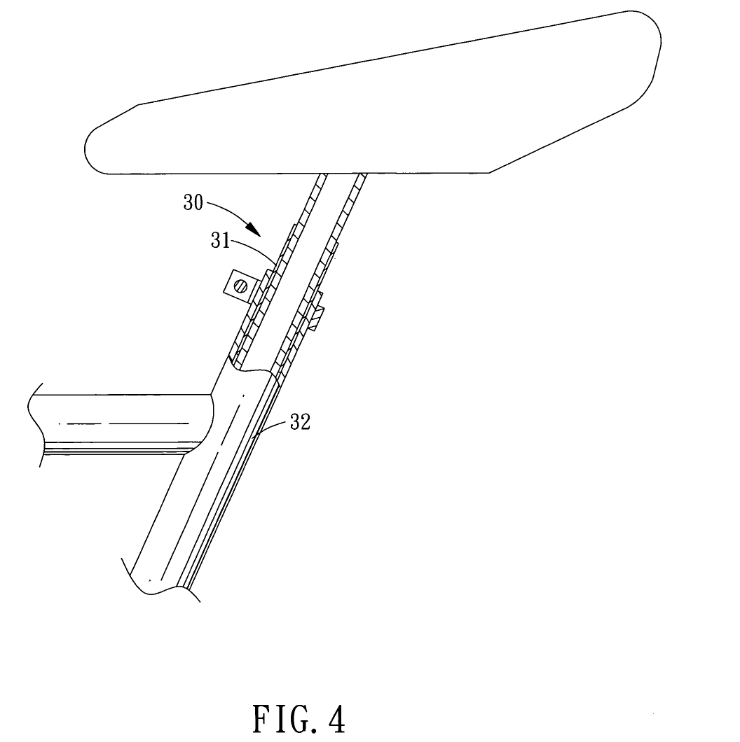

Referring to FIG. 4, the composite material tube in accordance with the present invention also can be a bicycle seat post 30, when the seat post 30 can be prevented from being scratched after it is assembled with the seat tube. Therefore, the seat post 30 will not only possess high resistance to abrasion, but also it will be improved in impact strength.

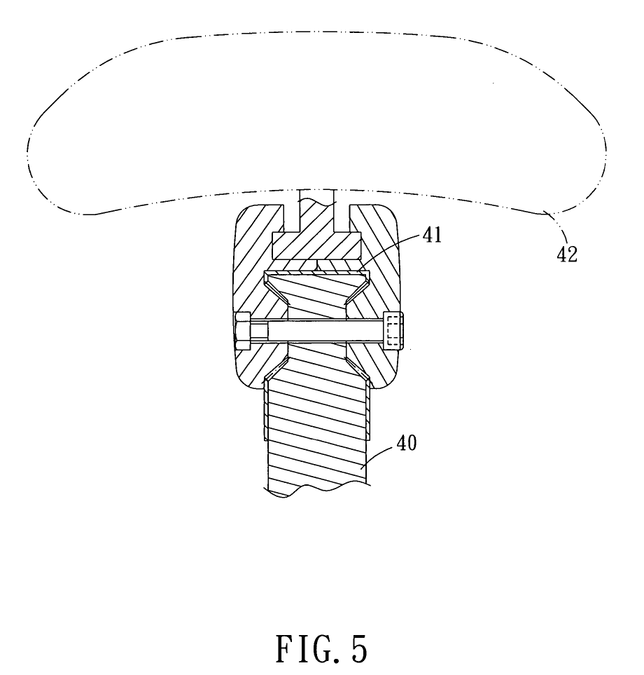

Referring to FIG. 5, when the composite material tube in accordance with the present invention is a seat post 40 that is to be assembled with the bicycle seat, and the abrasion resistant layer 41 on the seat post 40 serves as an abutment, in other words, the abrasion resistant layer 41 is located on the top end of the seat post, so that the seat post 40 can be prevented from being scratched when it is assembled with the bicycle seat. Therefore, the seat post 40 will not only possess high resistance to abrasion, but also it will be improved in impact strength.

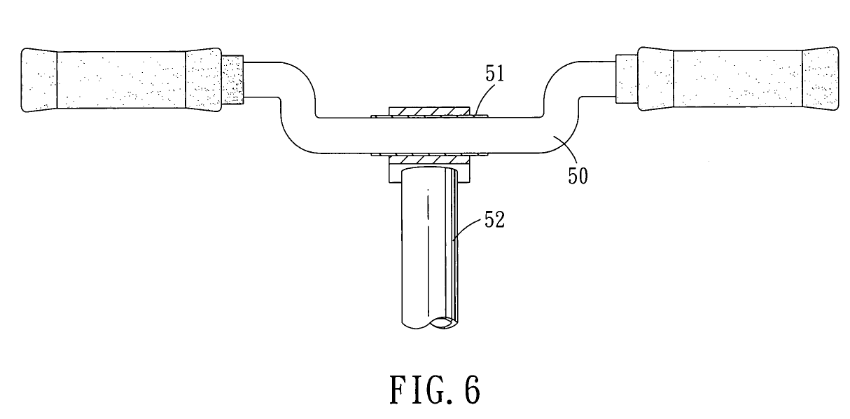

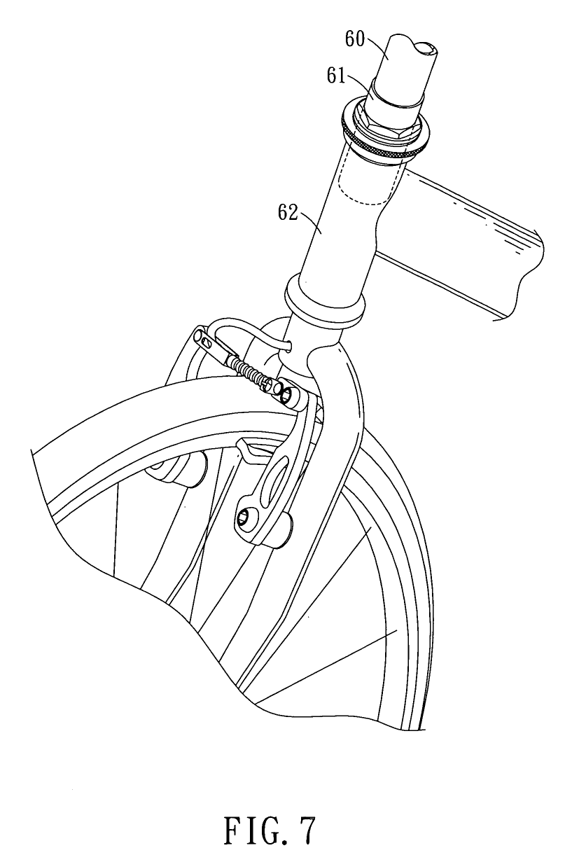

Referring to FIG. 6, when the composite material tube in accordance with the present invention is made into a bicycle handlebar 50 that is to be assembled with the handle stem of a bicycle, and the abrasion resistant layer 51 on the handlebar 50 can serve an abutment portion, so that the handlebar 50 can be prevented from being scratched when it is assembled with the handle stem. Therefore, the handlebar 50 will not only possess high resistance to abrasion, but also it will be improved in impact strength.

Referring to FIG. 7, when the composite material tube in accordance with the present invention is made into a bicycle handle stem 60 that is to be assembled with the front fork, and the abrasion resistant layer 61 on the handle stem 60 can serve as an abutment portion, so that the handle stem 60 can be prevented from abrasion after it is assembled with the front fork. Therefore, the handle stem 60 will not only possess high resistance to abrasion, but also it will be improved in impact strength.

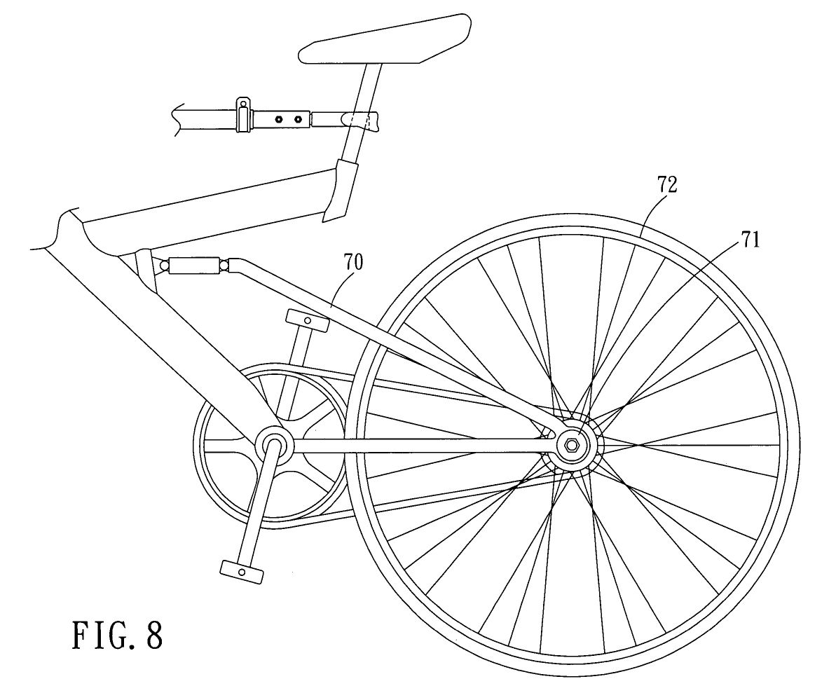

Referring to FIG. 8, an abrasion resistant composite material structure in accordance with a second preferred embodiment of the present invention is made into a bicycle frame 70 whose surface is partially laminated with an abrasion resistant layer 71 by means of paint spraying or any other processes. The abrasion resistant layer 71 is also made of Molybdenum Disulfide, Acrylics, nano-composite coating material, polyester coating material, or any other abrasion resistant materials. As shown in this figure, the abrasion resistant layer 71 serves as an abutment portion of the frame 70 relative to the rear wheel 72. By such arrangements, the abrasion resistant layer 71 can prevent the surface of the composite material frame 70 from being scratched, so that the frame 70 not only possesses the inherent characteristics of composite material, but also has high resistance to abrasion.

It is to be noted that the abrasion resistant layer can cover the whole surface of the composite material product. Through this way, the composite material product not only possesses high resistance to abrasion, but also has improved impact strength.

While we have shown and described various embodiments in accordance with the present invention, it should be clear to those skilled in the art that further embodiments may be made without departing from the scope of the present invention.

What is claimed is:

1. An abrasion resistant composite material structure comprising an abrasion resistant layer formed on a composite material product, wherein the abrasion resistant layer serves as an abutment portion of the composite material product to other components.

2. The abrasion resistant composite material structure as claimed in claim 1, wherein the abrasion resistant layer is made of Molybdenum Disulfide.

3. The abrasion resistant composite material structure as claimed in claim 1, wherein the abrasion resistant layer is made of Acrylics.

4. The abrasion resistant composite material structure as claimed in claim 1, wherein the abrasion resistant layer is made of polyester coating material.

5. The abrasion resistant composite material structure as claimed in claim 1, wherein the abrasion resistant layer is made of nano-composite coating material.

6. The abrasion resistant composite material structure as claimed in claim 1, wherein the composite material product is a bicycle frame, and the abrasion resistant layer is formed on a surface of the bicycle frame.

7. The abrasion resistant composite material structure as claimed in claim 1, wherein the composite material product is a bicycle seat post, and the abrasion resistant layer is formed on a surface of the bicycle seat post.

8. The abrasion resistant composite material structure as claimed in claim 1, wherein the composite material product is a bicycle handlebar, and the abrasion resistant layer is formed on a surface of the bicycle handlebar.

9. The abrasion resistant composite material structure as claimed in claim 1, wherein the composite material product is a bicycle handle stem, and the abrasion resistant layer is formed on a surface of the bicycle handle stem.

10. The abrasion resistant composite material structure as claimed in claim 1, wherein the composite material product is a tube, and the abrasion resistant layer is formed on a surface of the tube.
